(19) United States
(12) Patent Application Publication
(10) Pub. No.: US 2009/0043788 A1
(43) Pub. Date: Feb. 12, 2009

(54) Proactive business intelligence

(75) Inventors: Yaacov Averbuch, Netanya (IL); Assaf Ella, Gedera (IL); Yvan Montuelle, Kfar Yona (IL); Uri Rubin, Ramat Gan (IL)

Correspondence Address: Brux Software Solutions Ltd., 8 Gordon Street, Givatayim, 53235, IL

(73) Assignee: Panorama Software Inc., New York, NY (US)

(21) Appl. No.: 11/882,786

(22) Filed: Aug. 6, 2007

(51) Int. Cl. G06F 17/30

(52) U.S. Cl. 707/100; 707/E17.014

(57) ABSTRACT

A method of retrieving data items residing in a multidimensional database, comprising the steps of: storing previously created views from said multidimensional database in a storage connected with said database; searching said stored views for all views comprising a queried metadata search string; displaying said search results; selecting a view from said displayed views; selecting one or more items from said selected view; and transferring said selected one or more item to a receiving module, whereby said transferred one or more items retain their reference to said selected view for updating purposes.

### FIELD OF THE INVENTION

The invention relates to the field of Business Intelligence (BI) using multidimensional data, and more specifically to data retrieval technologies.

### BACKGROUND OF THE INVENTION

Online Analytical Processing, or OLAP is an approach known in the art to quickly provide answers to analytical queries that are multidimensional in nature. The typical applications of OLAP are in business reporting for sales, marketing, management reporting, business process management (BPM), budgeting and forecasting, financial reporting and similar areas.

Databases configured for OLAP employ a multidimensional data model, allowing for complex analytical and ad-hoc queries with a rapid execution time. The output of an OLAP query is typically displayed in a matrix (or pivot) format. The dimensions form the row and column of the matrix; the measures, the values.

In the core of any OLAP system is a concept of an OLAP cube (also called a multidimensional cube or a hypercube). It consists of numeric facts called measures which are categorized by dimensions. The cube metadata is typically created from a star schema or snowflake schema of tables in a relational database. Measures are derived from the records in the fact table and dimensions are derived from the dimension tables.

Using OLAP tehnologies is a complex task. Since the technology is based on multidimensional indexing of data, a major part of the analysis performed when using the BI system comprises of finding the correct “View” of the data. The user “slices” the information, using different dimensions, e.g. customer gender, various filtering rules, e.g. top ten selling products, etc, so as to define a view which will provide the relevant business insight, or a content to be used for creating an interesting report.

Thousands of views multiplied by thousands of configurations may be accumulated by an organization using BI tools, covering different models and reports. The problem thus arises, how to advantageously use this vast reservoir of previous searches, incorporating time-consuming intelligent work done in the organization, to facilitate and enhance future data searches.

### SUMMARY OF THE INVENTION

According to a first aspect of the present invention, there is provided a method of retrieving data items residing in a multidimensional database, comprising the steps of: a. storing previously created views from the multidimensional database in a storage connected with the database; b. searching the stored views for all views comprising a queried metadata search string; c. displaying the search results; d. selecting a view from the displayed views; e. selecting one or more items from the selected view; and f. transferring the selected one or more item to a receiving module, whereby the transferred one or more items retain their reference to the selected view for updating purposes; and wherein steps (d) through (f) may be repeated.

According to a first embodiment of this aspect, the search may comprise one of: a keyword search and a hierarchical tree search.

According to a second embodiment of this aspect, the order of displaying the search results is hierarchical, where the hierarchy may be established according to one of: the number of occurrences of the search string in the view metadata, the number of occurrences of the search string in the database metadata, the hierarchical structure of the searched views and the popularity of a view among a specific group of users.

According to a third embodiment of this aspect, selecting a view comprises modifying the selected view.

According to a fourth embodiment of this aspect, selecting a view comprises retrieving a different configuration of the selected view from the database.

According to a fifth embodiment of this aspect, selecting one or more items comprises selecting one or more ranges of adjacent items.

According to a sixth embodiment of this aspect, selecting one or more items comprises defining a sliding time-window of interest for the selected items.

According to a seventh embodiment of this aspect, transferring the selected one or more item comprises dragging the items to the receiving module.

According to an eighth embodiment of this aspect, the receiving module comprises a GUI container, where the GUI container may comprise metadata and numerical values pertaining to the metadata or KPIs.

According to an eighth embodiment of this aspect, the receiving module is incorporated in a task box within a business rule, wherein the business rule may be part of a business process workflow and wherein the task box is one of a triggering condition for and a decision point within the process workflow.

According to an ninth embodiment of this aspect, the business rule is adapted to update values within the task box in accordance with occurrences in another process connected with the task box.

According to a tenth embodiment of this aspect, the task box is adapted to be updated in accordance with value changes in the receiving module.

According to a tenth embodiment of this aspect, updating items within the receiving module may occur upon request, or periodically, or whenever triggered by a change in the corresponding values within the database.

According with a second aspect of the present invention, there is provided a method of retrieving data items residing in a multidimensional database, comprising the steps of: a. storing previously created views from the multidimensional database in a storage connected with the database; b. selecting a view from the stored views; c. selecting one or more items from the selected view; and d. transferring the selected one or more item to a receiving module, whereby the transferred one or more items retain their reference to the selected view for updating purposes; and wherein steps (b) through (d) may be repeated.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a block diagram showing the main components of the system according to one embodiment;

FIG. 2 shows two exemplary search methodologies used with the present invention;

FIG. 3 shows an exemplary user interface results window according to the present invention;

FIG. 4 is a block diagram showing the main components of the system according to another embodiment;

FIG. 5 shows the displayed container according to some embodiments of the invention;

FIG. 6 is a flowchart depicting the process of manually selecting items of interest according to some embodiments of the present invention;

FIG. 7 is a flowchart depicting the process of automatically selecting items of interest using business rules according to some embodiments of the present invention; and

FIG. 8 is a flowchart depicting the mechanism of the updating process according to some embodiments of the present invention.

### DETAILED DESCRIPTION OF PREFERRED EMBODIMENTS

In the following detailed description, numerous specific details are set forth regarding the system and method and the environment in which the system and method may operate, etc., in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Moreover, various examples are provided to explain the operation of the present invention. It should be understood that these examples are exemplary. It is contemplated that there are other methods and systems that are within the scope of the present invention.

The method of the present invention, as incorporated in a computer program, may be stored in a computer readable storage medium, such as, but not limited to, any type of disk including floppy disks, optical disks, CD-ROMs, magnetic-optical disks, read-only memories (ROMs), random access memories (RAMS) electrically programmable read-only memories (EPROMs), electrically erasable and programmable read only memories (EEPROMs), magnetic or optical cards, or any other type of media suitable for storing electronic instructions, and capable of being coupled to a computer system bus. In addition, embodiments of the present invention are not described with reference to any particular programming language. It will be appreciated that a variety of programming languages may be used to implement the teachings of the inventions as described herein.

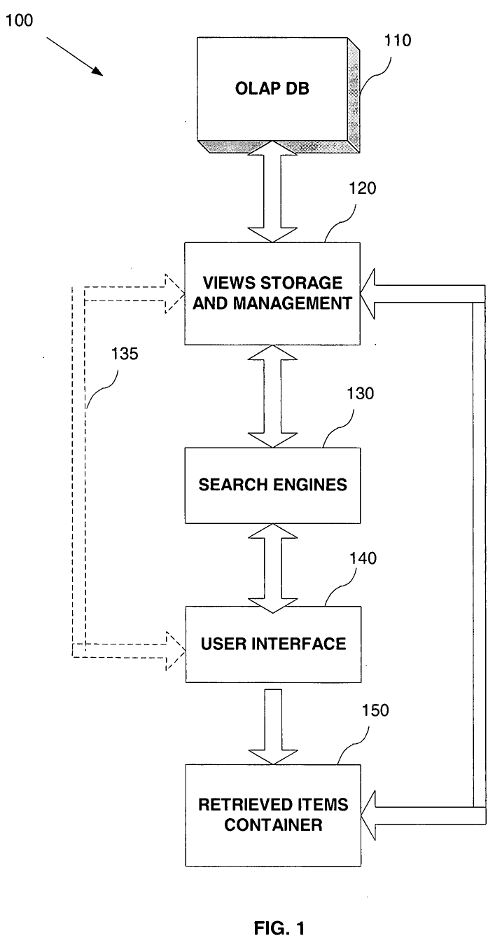

FIG. 1 is a block diagram showing the main components of the system 100 according to one embodiment of the present invention. The system comprises an OLAP database (or cube) 110, a views storage and management module 120 storing previously created views or reports, one or more search engines 130 for searching the stored views, a user interface 140 for defining the search terms and methodology and a retrieved items container 150 for storing the items retrieved by searching the stored views.

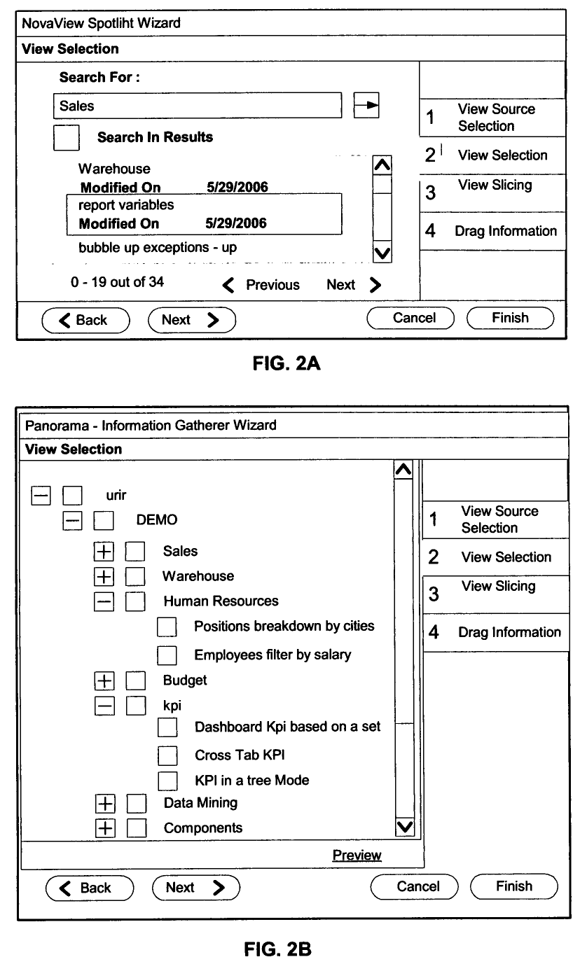

User interface 140 may present the user with various search methodologies, such as search by keywords (FIG. 2A) preferably using Boolean operators, hierarchical tree search over the content directory of the views storage and management module 120 (FIG. 2B), or any other search methodology known in the art. The keyword search may pertain to views' metadata including dimension names, e.g. sales AND California AND 1997, and/or metrics such as sales GREATER THAN $100 or annotations defined for various BI entities, such as annotations for formulas, exceptions, KPIs, etc.

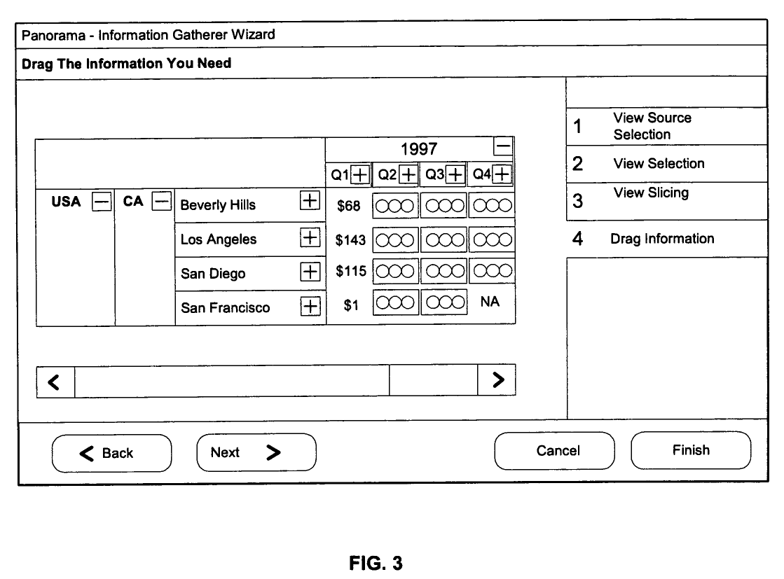

Search engine(s) 130 queries the views storage and management module 120 for the views responding to the user's query and the matching views are displayed to the user via user interface 140. FIG. 3 shows an exemplary user interface window in which a retrieved view is displayed.

The order of displaying the retrieved views may be determined according to various ranking algorithms. Following are some non-limiting examples:
a. The number of occurrences of the search string in the view (or cube) metadata;
b. The hierarchical tree structure (physical and/or display folders);
c. The popularity (number of hits) of a view among a specific group of users, e.g. sales force, or all the B users;
d. One of the view or cube properties, e.g. view\cube Author name, modification date, cube name and type and more.
e. A combination of some or all of the above.

The user may now flip through the views provided by the search engine 130 and indicate items of interest from within the viewed information. Indicating the selected items may be done using any selection tool known in the art of graphical user interfaces, such as, but not limited to, clicking on the displayed item. The system may highlight the selected items by changing their color, changing their background color, etc. The items thus indicated will be saved in the retrieved items container 150 as “living” items, i.e. the items in the container 150 will be constantly updated, as will be explained in more detail below.

According to some non-limiting embodiments, the user may move the selected items into the container by a drag-and-drop operation. The moved items may comprise a single cell, a range of cells or the entire view.

According to some embodiments, a range of cells moved as one unit may retain their unity throughout subsequent operations, e.g. slicing, performed on container 150, as will be explained in detail below.

According to some embodiments, the user may directly access the views storage via user interface 140, as indicated by dotted arrow 135, display a view and select items from within the displayed view as explained above, for saving in container 150. The user interface for directly accessing views may alternatively belong to another application, e.g. a views analyzing application.

According to some embodiments, the user may also modify the views logic on the fly e.g. add calculation, exceptions, etc., as provided by the application used to display the views.

According to some embodiments, the user may wish to retrieve an item which does not show in the selected view's present configuration. For example, in the example of FIG. 3, sales figures for four cities in California are shown, for the year 1997. The figures may pertain to total sales, while the user is currently interested in the sales of a specific product (e.g. milk). The user may request the appropriate slicing, in which case the views storage and management module 120 may query the OLAP database for the required view configuration and present it to the user.

According to some embodiments, the updated configuration may be based on more than one parameter. For example, the user may request milk sales to males only. The compound request will be handled in a similar manner as described above.

According to some embodiments, the user may wish to ignore the dates presented in the displayed view and define a sliding timeframe of interest for some or all of the items selected from this view, such as “the last month” or “the last week”. These items, when residing in retrieved items container 150, will thus continuously be updated with the requested data items' values pertaining to the requested window of time. Alternatively or additionally, the user may define time related parameters such as, but not limited to average of the last n periods, best period, etc.

According to some embodiments, when a user drags a list of values from a view they may treated as a unit. For example, for a view that shows the top five products (rows) sold for December (column), if the user drags this column into the container and select “last month”, all of the metrics in this column in the container will be removed and replaced with newest five best products each month.

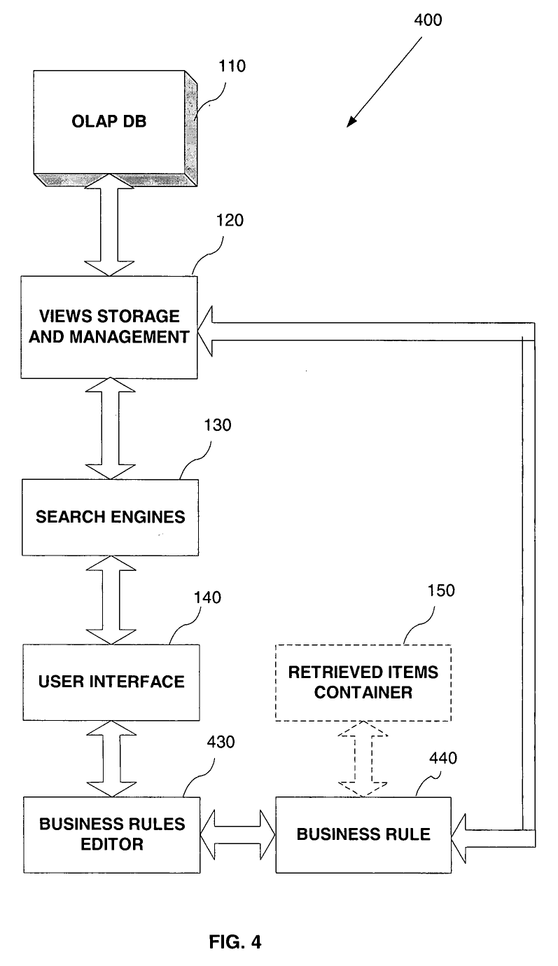

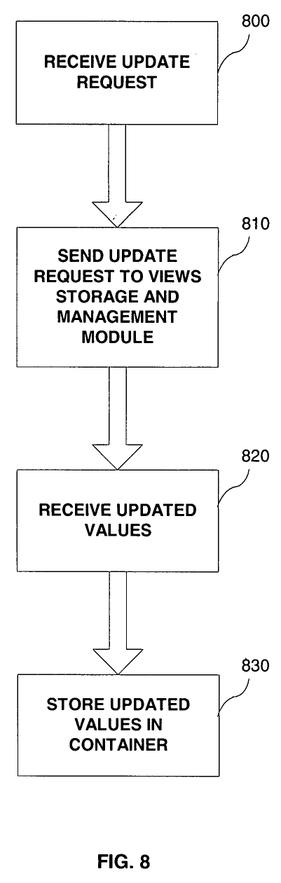

FIG. 4 is a block diagram showing the main components of the system 400 according to another embodiment of the present invention. System components identical to those shown in FIG. 1 have identical numerals. In the embodiment of FIG. 4, a business rules editing module 430 serves both for triggering a views search and for receiving the retrieved items in lieu of container 150. For example, a business rule 440 may comprise a flowchart, incorporated e.g. in a MS Workflow foundation editor or BizTalk. The flowchart may include “task boxes” or “activities” which, upon activation, may launch user interface 140. The user may now search or browse through stored views, as explained above in conjunction with the embodiment of FIG. 1 and select items of interest in a similar manner. Once selected, the items may be dragged to the task box within the business rule. The business rule is now attached to the selected view and will undergo automatic updating as described below in conjunction with FIG. 8. The item thus incorporated in the business rule may now serve either as the part of the triggering condition of the process or as a decision point inside the process.

According to some embodiments, the task box incorporated in a business rule may additionally be connected with container 150, as indicated by the dotted lines in FIG. 4. This additional connection allows the business rule to automatically update the container's content, e.g. as a result of an incident occurring in another process. The task box may also be automatically updated by changes in the container's content.

According to some embodiments, a task box within a business rule may be connected to other relational tables, other than container 150 and similarly have the capability of updating or be updated by those tables.

These connections enable an organization to build and maintain hierarchical processes according to different levels of metadata. For example, the organization may define process A; as process A runs it can update container 150; the updated item in container 150 can be used to trigger process B, which is a process that monitors process A.

The business rule itself may be part of a business workflow and may be triggered, for example, at decision junctions. For example, an organizational workflow may reach a decision junction where different actions may be taken depending on any number of metrics, such as sales figure, number of employees, etc. The workflow according to this embodiment may trigger a business rule that incorporates an updatable item as described above, whereby the workflow may trigger an appropriate action as defined in the workflow logic.

According to some embodiments, items retrieved by business rules may apply to more than one user. However, different user may receive different aspects of the same data, depending on various criteria such as rank, security clearance, department, etc.

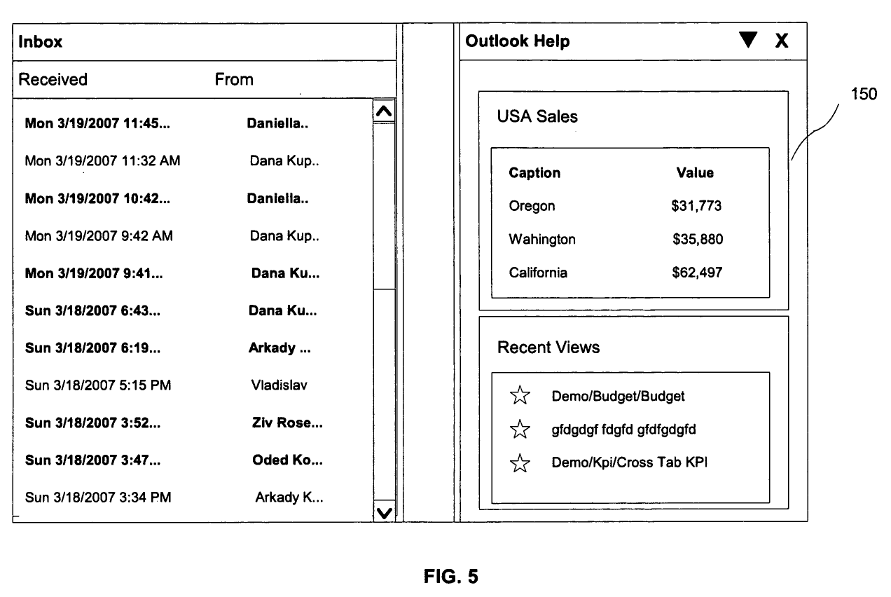

According to a preferred embodiment of the present invention, retrieved items container 150 may be displayed, as shown in FIG. 5. The container may be displayed in the context of any application having a user interface, such as, for example, Microsoft Office applications Word, Excel, Outlook etc., by using Net Shared Addin and Visual Studio Tools for Office V3. This is accomplished, for example, by adding a custom Office Task pane, and populating it with container 150. The container may be dragged into a MS Outlook task and be activated for updating in accordance with the task definitions, e.g. once a week, or into a mail message. The container may be also dragged into Excel\Word\Powepoint documents, to display its content within these documents. The container may be also displayed within Google side bar\Vista gadgets.

The displayed container may include captions, i.e. item names, values of the items and KPIs (Key Performance Indicators) qualifying the presented quantities. For example, a KPI may indicate that a sales figure of $500,000 in the requested timeframe is above average.

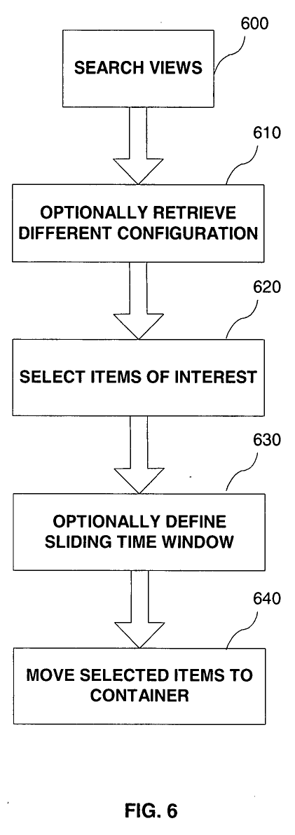

FIG. 6 is a flowchart depicting the process of manually selecting items of interest according to some embodiments of the present invention, as described in detail above. In step 600 the user initiates a search of the stored views, in step 610 the user views the displayed views and optionally defines a different configuration to be viewed, in step 620 the user selects items of interest, in step 630 the user optionally defines a sliding time-window and in step 640 the user moves the selected items into the container.

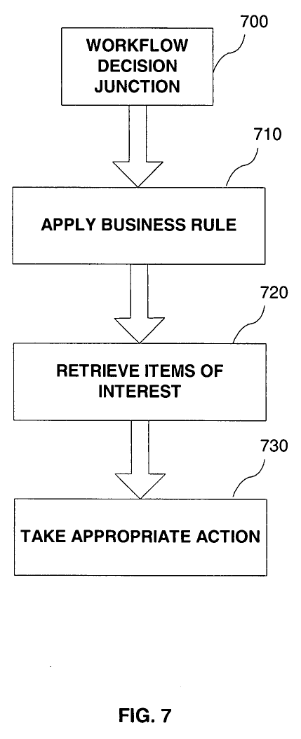

FIG. 7 is a flowchart depicting the process of automatically selecting items of interest using business rules. In step 700 a running business workflow reaches a decision junction, in step 710 one or more business rules are applied, as defined in the workflow process, in step 720 the items of interest defined in the business rule(s) are retrieved and in step 730 an appropriate action is taken, as defined in the workflow process, in accordance with the values of the retrieved items. Alternatively, the retrieved items may be stored and serve as input for another process.

Once the retrieved items container 150 has been populated in any of the manners described above, it may now be used to provide continuously updated information, relevant to the specific user or to the organization.

FIG. 8 is a flowchart depicting the mechanism of the updating process according to some embodiments of the present invention. In step 800 an update request is received. According to some embodiments, the data in the container is updated at predefined times or time intervals. Alternatively, the data in the container is updated by specific request of the user. The update is controlled by a software module embedded in the container. In step 810 an update request is sent to the views storage and management module 120, in step 820 an updated list of values for the requested items is provided and in step 830 the updated values are stored in the retrieved items container 150 and preferably displayed in the container window.

According to some embodiments, the data in the container may be updated whenever the source data in the OLAP database is changed. For example, part of the ETL process used for processing or updating the cube may trigger the reevaluation of the BI entities, e.g. by asking a workflow with starting condition(s) related to BI to recheck its starting condition(s).

According to some embodiments, the data in the container may be updated conditionally, e.g. until a value reaches a predefined limit.

According to some embodiments, logical or mathematical operations may be performed, manually or automatically, with or between container's items. For example, a quotient of two items' values e.g. total revenue from milk sales and number of milk gallons sold may be automatically calculated whenever at least one of the values changes, resulting in an average revenue/gallon. The result may be accompanied by a KPI showing, for example, the calculated average price as compared to previous year's average price.

According to some embodiments, slicing operations may be interactively performed on container 150's items. For example, the user may select from a predefined list of dimensions (period, areas, product) a slicing that will affect all or part of the metrics in the container.

According to some embodiments, an item's value within the container, or metadata connected with the item, e.g. the item's owner, may automatically trigger one or more operations or processes. For example, whenever an item owned by a certain individual changes above or below a predefined threshold, an e-mail message may be automatically sent to the owner.

According to some embodiments, the system is capable of “learning” a user's mode of operation, or set of repeating operations and automatically come up with suggestions. For example, if many users select to ‘drill-though’ from a metrics KPI into a view that shows more information about it, this option will move up in the list of options offered to the user, or, if many users select a certain process to start out of 10 possible offered processes, it will move to the beginning of the list

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. A method of retrieving data items residing in a multidimensional database, comprising the steps of:
a. storing previously created views from said multidimensional database in a storage connected with said database;
b. searching said stored views for all views comprising a queried metadata search string;
c. displaying said search results;
d. selecting a view from said displayed views;
e. selecting one or more items from said selected view; and
f. transferring said selected one or more item to a receiving module,
whereby said transferred one or more items retain their reference to said selected view for updating purposes; and
wherein steps (d) through (f) may be repeated.

2. A method of retrieving data items residing in a multidimensional database, comprising the steps of:
a. storing previously created views from said multidimensional database in a storage connected with said database;
b. selecting a view from said stored views;
c. selecting one or more items from said selected view; and
d. transferring said selected one or more item to a receiving module,
whereby said transferred one or more items retain their reference to said selected view for updating purposes; and
wherein steps (b) through (d) may be repeated.

3. The method of claim 1, wherein said search comprises one of: a keyword search and a hierarchical tree search.

4. The method of claim 1, wherein the order of displaying said search results is hierarchical.

5. The method of claim 4, wherein said hierarchy is established according to one of: the number of occurrences of the search string in the view metadata, the number of occurrences of the search string in the database metadata, the hierarchical structure of the searched views and the popularity of a view among a specific group of users.

6. The method of claim 1, wherein said selecting a view comprises modifying said selected view.

7. The method of claim 2, wherein said selecting a view comprises modifying said selected view.

8. The method of claim 1, wherein said selecting a view comprises retrieving a different configuration of said selected view from said database.

9. The method of claim 2, wherein said selecting a view comprises retrieving a different configuration of said selected view from said database.

10. The method of claim 1, wherein selecting one or more items comprises selecting one or more ranges of adjacent items.

11. The method of claim 2, wherein selecting one or more items comprises selecting one or more ranges of adjacent items.

12. The method of claim 1, wherein said selecting one or more items comprises defining a sliding time-window of interest for said selected items.

13. The method of claim 2, wherein said selecting one or more items comprises defining a sliding time-window of interest for said selected items.

14. The method of claim 1, wherein transferring said selected one or more item comprises dragging said items to said receiving module.

15. The method of claim 2, wherein transferring said selected one or more item comprises dragging said items to said receiving module.

16. The method of claim 1, wherein said receiving module comprises a GUI container.

17. The method of claim 2, wherein said receiving module comprises a GUI container.

18. The method of claim 16, wherein said GUI container comprises metadata and numerical values pertaining to said metadata.

19. The method of claim 17, wherein said GUI container comprises metadata and numerical values pertaining to said metadata.

20. The method of claim 16, wherein said GUI container comprises KPIs.

21. The method of claim 17, wherein said GUI container comprises KPIs.

22. The method of claim 1, wherein said receiving module is incorporated in a task box within a business rule.

23. The method of claim 2, wherein said receiving module is incorporated in a task box within a business rule.

24. The method of claim 22, wherein said business rule is part of a business process workflow.

25. The method of claim 23, wherein said business rule is part of a business process workflow.

26. The method of claim 24, wherein said task box is one of a triggering condition for and a decision point within said process workflow.

27. The method of claim 25, wherein said task box is one of a triggering condition for and a decision point within said process workflow.

28. The method of claim 22, wherein said business rule is adapted to update values within said task box in accordance with occurrences in another process connected with said task box.

29. The method of claim 23, wherein said business rule is adapted to update values within said task box in accordance with occurrences in another process connected with said task box.

30. The method of claim 22, wherein said task box is adapted to be updated in accordance with value changes in said receiving module.

31. The method of claim 23, wherein said task box is adapted to be updated in accordance with value changes in said receiving module.

32. The method of claim 1, wherein said updating of items within said receiving module occurs upon request.

33. The method of claim 2, wherein said updating of items within said receiving module occurs upon request.

34. The method of claim 1, wherein said updating of items within said receiving module occurs periodically.

35. The method of claim 2, wherein said updating of items within said receiving module occurs periodically.

36. The method of claim 1, wherein said updating of items within said receiving module occurs whenever triggered by a change in the corresponding values within the database.

37. The method of claim 2, wherein said updating of items within said receiving module occurs whenever triggered by a change in the corresponding values within the database.

38. A computer-readable medium having computer-executable instructions stored thereon which, when executed by a computer, will cause the computer to perform the method of claim 1.

39. A computer-readable medium having computer-executable instructions stored thereon which, when executed by a computer, will cause the computer to perform the method of claim 2.

40. A computer system retrieving data items residing in a multidimensional database, comprising:
storage means for storing previously created views from said multidimensional database in a storage connected with said database;
search means connected with said storage means, for searching said stored views for all views comprising a queried metadata search string;
display means connected with said search means, for displaying said search results;
GUI means for selecting a view from said displayed views and for selecting one or more items from said selected view; and
means for transferring said selected one or more item to a receiving module, whereby said transferred one or more items retain their reference to said selected view for updating purposes.

41. A computer system for retrieving data items residing in a multidimensional database, comprising:
storage means for storing previously created views from said multidimensional database in a storage connected with said database;
display means connected with said storage means, for displaying selected views from said storage;
GUI means for selecting one or more items from said selected view; and
means for transferring said selected one or more item to a receiving module, whereby said transferred one or more items retain their reference to said selected view for updating purposes.

42. The system of claim 40, wherein said search means comprise one of: a keyword search and a hierarchical tree search.

43. The system of claim 40, wherein the order of displaying said search results is hierarchical.

44. The system of claim 43, wherein said hierarchy is established according to one of: the number of occurrences of the search string in the view metadata, the number of occurrences of the search string in the database metadata, the hierarchical structure of the searched views and the popularity of a view among a specific group of users.

45. The system of claim 39, wherein said means for selecting a view comprise means for modifying said selected view.

46. The system of claim 40, wherein said means for selecting a view comprise means for modifying said selected view.

47. The system of claim 39, wherein said means for selecting a view comprise means for retrieving a different configuration of said selected view from said database.

48. The system of claim 40, wherein said means for selecting a view comprise means for retrieving a different configuration of said selected view from said database.

49. The system of claim 39, wherein said means for selecting one or more items comprise means for selecting one or more ranges of adjacent items.

50. The system of claim 40, wherein said means for selecting one or more items comprise means for selecting one or more ranges of adjacent items.

51. The system of claim 39, wherein said means for selecting one or more items comprise means for defining a sliding time-window of interest for said selected items.

52. The system of claim 40, wherein said means for selecting one or more items comprise means for defining a sliding time-window of interest for said selected items.

53. The system of claim 39, wherein said means for transferring said selected one or more item comprise means for dragging said items to said receiving module.

54. The system of claim 40, wherein said means for transferring said selected one or more item comprise means for dragging said items to said receiving module.

55. The system of claim 39, wherein said receiving module comprises a GUI container.

56. The system of claim 40, wherein said receiving module comprises a GUI container.

57. The system of claim 55, wherein said GUI container comprises metadata and numerical values pertaining to said metadata.

58. The system of claim 56, wherein said GUI container comprises metadata and numerical values pertaining to said metadata.

59. The system of claim 55, wherein said GUI container comprises KPIs.

60. The system of claim 56, wherein said GUI container comprises KPIs.

61. The system of claim 39, wherein said receiving module is incorporated in a task box within a business rule.

62. The system of claim 40, wherein said receiving module is incorporated in a task box within a business rule.

63. The system of claim 61, wherein said business rule is part of a business process workflow.

64. The system of claim 62, wherein said business rule is part of a business process workflow.

65. The system of claim 63, wherein said task box is one of a triggering condition for and a decision point within said process workflow.

66. The system of claim 64, wherein said task box is one of a triggering condition for and a decision point within said process workflow.

67. The system of claim 61, wherein said business rule is adapted to update values within said task box in accordance with occurrences in another process connected with said task box.

68. The system of claim 62, wherein said business rule is adapted to update values within said task box in accordance with occurrences in another process connected with said task box.

69. The system of claim 61, wherein said task box is adapted to be updated in accordance with value changes in said receiving module.

70. The system of claim 62, wherein said task box is adapted to be updated in accordance with value changes in said receiving module.

71. The system of claim 39, wherein said updating of items within said receiving module occurs upon request.

72. The system of claim 40, wherein said updating of items within said receiving module occurs upon request.

73. The system of claim 39, wherein said updating of items within said receiving module occurs periodically.

74. The system of claim 40, wherein said updating of items within said receiving module occurs periodically.

75. The method of claim 39, wherein said updating of items within said receiving module occurs whenever triggered by a change in the corresponding values within the database.

76. The system of claim 40, wherein said updating of items within said receiving module occurs whenever triggered by a change in the corresponding values within the database.
